(19) United States
(12) Patent Application Publication
(10) Pub. No.: US 2014/0362510 A1
(43) Pub. Date: Dec. 11, 2014

(54) INFORMATION PROCESSING APPARATUS

(71) Applicant: SONY CORPORATION, TOKYO (JP)

(72) Inventors: Shinsaku Hirano, Kanagawa (JP); Yuuki Kubota, Tokyo (JP); Hiroshi Tamaki, Nagano (JP); Kengo Masaoka, Nagano (JP)

(73) Assignee: SONY CORPORATION, TOKYO (JP)

(21) Appl. No.: 14/288,940

(22) Filed: May 28, 2014

(30) Foreign Application Priority Data
Jun. 5, 2013 (JP) 2013-118917

(51) Int. Cl. G06F 1/16; G06F 1/18

(52) U.S. Cl. CPC G06F 1/1669; G06F 1/1654; G06F 1/189
USPC 361/679.17

(57) ABSTRACT

Provided is an information processing apparatus including a first device including a display unit, a second device configured to perform at least one of input and output of information and to perform transfer of the information to/from the first device by communication, and a wrong orientation detection part configured to detect whether the first and second devices are overlapped with each other in a correct orientation. The first device includes a plurality of first magnets. The second device includes a plurality of second magnets. The first and second magnets are arranged at respective positions which overlap with each other when the first and second devices are overlapped with each other, in the first and second devices, respectively. The first and second devices are locked to each other by force with which the first and second magnets attract each other when the first and second devices are overlapped with each other.

### CROSS REFERENCE TO RELATED APPLICATIONS

This application claims the benefit of Japanese Priority Patent Application JP 2013-118917 filed Jun. 5, 2013, the entire contents of which are incorporated herein by reference.

### BACKGROUND

The present technology relates to an information processing apparatus and specifically relates to an information processing apparatus in which devices separately configured are overlapped with each other and which is portable.

Notebook-type personal computers are prevailing as portable personal computers in recent years. A notebook-type personal computer is configured in which a display and a keyboard are maintained to be overlapped with each other by the display folded on the keyboard with engagement parts engaged with each other (for example, see JP 2008-112328A which is hereinafter referred to as Patent Literature 1).

### SUMMARY

Personal computers called tablet-type ones or the like are prevailing in recent years. A tablet-type personal computer is configured to include a touch panel and be operable with its display screen seen by the user. While an input device such as a keyboard is not necessarily needed, there is also a case where the input device such as a keyboard is preferable in inputting text.

When the technology disclosed in Patent Literature 1 by way of example is applied to the device as above, since the keyboard is coupled with the display via an attachment part, it is difficult for the display and the keyboard to be used apart from each other. Therefore, in their usage as a tablet, the keyboard is not separate from the main body, causing deterioration of usability as a tablet.

For example, it is desired that a tablet-type personal computer is configured to be operable with a keyboard when the keyboard is wanted to use and is configured to be operable without deterioration of usability as a tablet when the keyboard is not used.

It is desirable to provide devices which are different devices such, for example as a keyboard and a display used in association with each other as necessary to be portable with them overlapped on each other or to be used separately.

According to an embodiment of the present disclosure, there is provided an information processing apparatus including a first device including a display unit, a second device configured to perform at least one of input and output of information and to perform transfer of the information to/from the first device by communication, and a wrong orientation detection part configured to detect whether or not the first device and the second device are overlapped with each other in a correct orientation. The first device includes a plurality of first magnets. The second device includes a plurality of second magnets. The first magnets and the second magnets are arranged at respective positions which overlap with each other when the first device and the second device are overlapped with each other, in the first device and the second device, respectively. The first device and the second device are locked to each other by force with which the first magnets and the second magnets attract each other when the first device and the second device are overlapped with each other.

The wrong orientation detection part may be configured such that at least one pole of the first magnet out of poles of the plurality of first magnets on a face side on which the display unit is included is a different pole from the others of the first magnets.

The first device further may include a power supplying terminal configured to supply power to the second device. The second device may further include a power receiving terminal configured to receive the power supplied from the first device. The power supplying terminal and the power receiving terminal may be arranged at respective positions where the power supplying terminal and the power receiving terminal are set in a connection state when the first device and the second device are overlapped with each other, in the first device and the second device, respectively. A battery of the second device may be charged when the power supplying terminal and the power receiving terminal are connected to each other.

One of the power supplying terminal and the power receiving terminal may have a convex shape with a curved surface on a part of the shape and the other has a concave shape with a curved surface on a part of the shape.

The wrong orientation detection part may be constituted of the power supplying terminal and the power receiving terminal.

The first device may further include a power supplying unit configured to supply power to the second device. The second device may further include a power receiving unit configured to receive the power supplied from the first device. The power supplying unit and the power receiving unit may be arranged at respective positions where the power supplying unit and the power receiving unit are overlapped with each other when the first device and the second device are overlapped with each other, in the first device and the second device, respectively. A battery of the second device may be charged when the power supplying unit and the power receiving unit are overlapped with each other.

The second device may be a device including at least any of a keyboard, a touch pad, a pen tablet and a loud speaker.

The second device may be configured to be overlapped on a face on which the display unit of the first device is provided or on a rear face of the first device and an overlapping state thus configured is maintained by the force with which the first magnets and the second magnets attract each other.

The information processing apparatus may be configured to function as a tablet-type personal computer when the second device is overlapped on a rear face of the first device.

A part in the second device corresponding to the display unit may be configured to be depressed below an edge part of the second device such that the display unit of the first device does not come into contact with the second device when the first device and the second device are overlapped with each other.

A supporting part configured to support the first device may be provided on a rear face of the first device. The supporting part may be provided to be opened and closed freely with respect to the first device.

A relief may be provided in an outer circumferential part of the display unit of the first device.

According to an embodiment of the present disclosure, there is provided an information processing apparatus including a first device configured to supply power, a second device configured to receive the power supplied from the first device, and a wrong orientation detection part configured to detect whether or not the first device and the second device are overlapped with each other in a correct orientation. The first device includes a plurality of first magnets. The second device includes a plurality of second magnets. The first magnets and the second magnets are arranged at respective positions which overlap with each other when the first device and the second device are overlapped with each other, in the first device and the second device, respectively. The first device and the second device are locked to each other by force with which the first magnets and the second magnets attract each other when the first device and the second device are overlapped with each other.

A first information processing apparatus according to an embodiment of the present technology includes: a first device including a display unit; and a second device configured to perform at least one of input and output of information. The second device performs transfer of the information to/from the first device by means of communication. The first device includes a plurality of first magnets. The second device includes a plurality of second magnets. The first magnets and the second magnets are arranged at respective positions which overlap with each other when the first device and the second device are overlapped with each other, in the first device and the second device, respectively. The first device and the second device are locked to each other by force with which the first magnets and the second magnets attract each other when the first device and the second device are overlapped with each other. Moreover, whether or not the first device and the second device are overlapped with each other in a correct orientation is configured to be detected and they are configured to be overlapped and locked to each other in the correct orientation.

A second information processing apparatus according to an embodiment of the present technology includes: a first device configured to supply power; and a second device configured to receive the power supplied from the first device. The first device includes a plurality of first magnets. The second device includes a plurality of second magnets. The first magnets and the second magnets are arranged at respective positions which overlap with each other when the first device and the second device are overlapped with each other, in the first device and the second device, respectively. The first device and the second device are locked to each other by force with which the first magnets and the second magnets attract each other when the first device and the second device are overlapped with each other. Moreover, whether or not the first device and the second device are overlapped with each other in a correct orientation is configured to be detected and they are configured to be overlapped and locked to each other in the correct orientation.

According to an embodiment of the present technology, there are provided devices which are different devices such, for example as a keyboard and a display used in association with each other as necessary to be portable with them overlapped on each other or to be used separately.

### BRIEF DESCRIPTION OF THE DRAWINGS

FIG. 1 is a diagram illustrating a configuration of an information processing apparatus according to an embodiment to which the present technology is applied;

FIG. 2 is a diagram illustrating a configuration of appearance on a rear face of the information processing apparatus;

FIG. 3 is a diagram illustrating a configuration of the appearance when a supporting part is opened;

FIG. 4 is a diagram illustrating an internal configuration of a main body in the information processing apparatus;

FIG. 5 is a diagram illustrating an internal configuration of an input/output unit in the information processing apparatus;

FIG. 6 is a diagram illustrating overlapping of the main body with the input/output unit;

FIG. 7 is a diagram for explaining a structure for attaching the main body to the input/output unit;

FIG. 8 is a diagram for explaining attachment in a correct orientation;

FIG. 9 is a diagram for explaining the attachment in a wrong orientation;

FIG. 10 is a diagram for explaining an arrangement of magnets;

FIG. 11 is a diagram for explaining an arrangement of the magnets;

FIG. 12 is a diagram for explaining an arrangement of the magnets;

FIG. 13 is a diagram for explaining a configuration of terminals;

FIG. 14 is a diagram for explaining overlapping;

FIG. 15 is a diagram for explaining overlapping;

FIG. 16 is a diagram for explaining a space between a keyboard and a display unit;

FIG. 17 is a diagram illustrating a configuration of appearance of an information processing apparatus that performs contactless charging;

FIG. 18 is a diagram for explaining a configuration regarding the contactless charging;

FIGS. 19A and 19B are diagrams for explaining a relief provided in the main body;

FIG. 20 is a diagram for explaining attachment of an input unit to a rear face of the main body; and

FIG. 21 is a diagram for explaining an arrangement of the magnets.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. Notably, the description is made in the following order.

1. Configuration of Appearance of Information Processing Apparatus

2. Internal Configuration of Information Processing Apparatus

3. Overlapping for Information Processing Apparatus

4. Locking Using Magnets

5. Configuration of Terminals

6. Contactless Charging

7. Attachment on Rear Face

8. Overlapping for Information Processing Apparatus Using Electromagnets

### <Configuration of Appearance of Information Processing Apparatus>

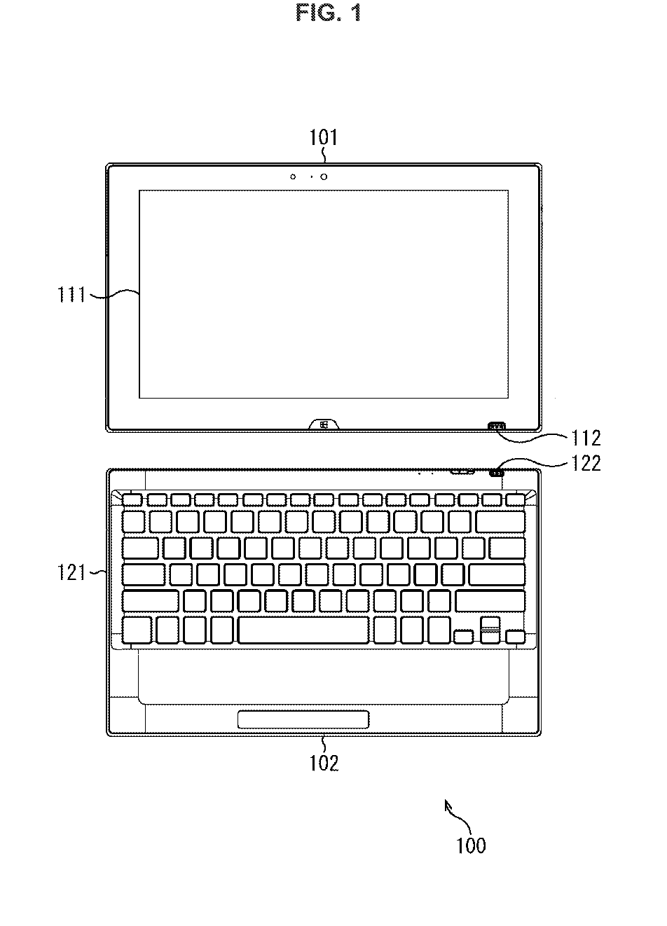

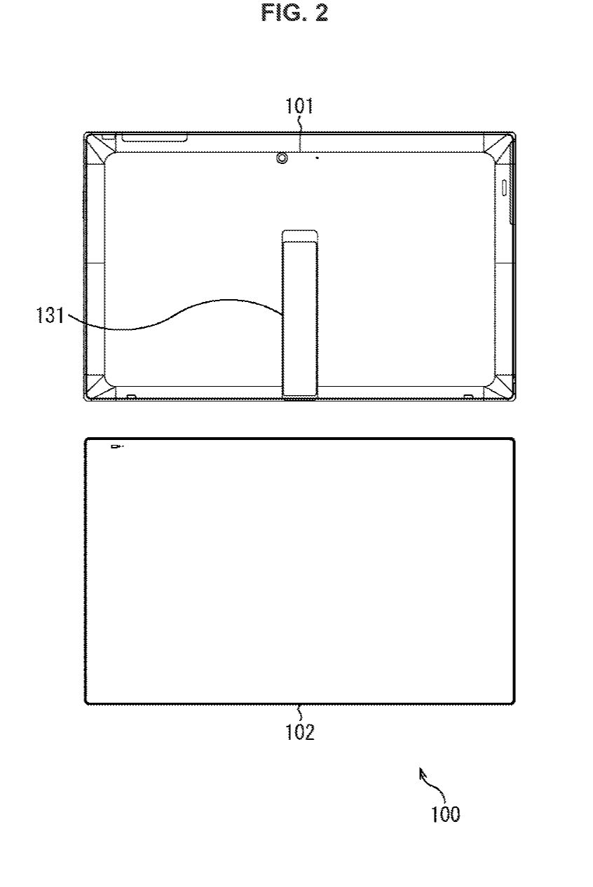

FIG. 1 and FIG. 2 are diagrams illustrating a configuration of appearance of an information processing apparatus according to an embodiment to which the present technology is applied. An information processing apparatus 100 includes a main body 101 and an input/output unit 102 which are separately configured and perform transfer of data in a wireless manner. A display unit 111 is provided on a front face of the main body 101. A keyboard 121 is provided on a front face of the input/output unit 102.

Operation data of the keyboard 121 is supplied to the main body 101 side in wireless communication. As above, the information processing apparatus 100 according to the embodiment is divided into the main body 101 and the input/output unit 102 which are configured to perform transfer of data in a wireless manner. In this way, the main body 101 and the input/output unit 102 are configured to be placed apart from each other.

For example, text inputted by operation of the keyboard 121 of the input/output unit 102 is displayed on the display unit 111 of the main body 101.

Notably, the description herein continues, supposing that the transfer of data is performed in a wireless manner, whereas the transfer of data may be performed under the connection with a predetermined cable such as a USB (Universal Serial Bus) cable.

The description is herein made for a configuration including the keyboard 121 by way of example as the input/output unit 102, whereas there also can be a configuration including a touch pad, a pen tablet or the like, or a configuration of a combination of these, for example, including the keyboard 121 and the touch pad.

Moreover, the description herein continues with an input device by way of example as the input/output unit 102, whereas there can also be an output device such as a loud speaker as it. For example, the input/output unit 102 may be configured as a loud speaker receiving data from the main body 101 and outputting music. Of course, the input/output unit 102 can also be configured to be constituted of the keyboard 121 and the loud speaker and to function as both of the input device and the output device.

Moreover, the description herein continues, supposing that input is performed by the input/output unit 102, whereas there can also be a configuration, for example, in which the main body 101 side also includes a device capable of inputting information. For example, there can also be a configuration in which a touch panel (not shown) is provided on the surface of the display unit 111 and information is inputted by operation of the touch panel provided in the main body 101.

In the case of the touch panel provided in the display unit 111, the main body 101 can be used as a device solely operating, for example, as a computer called a tablet or the like.

The main body 101 and the input/output unit 102 of the information processing apparatus 100 are configured such that they can be overlapped with each other. While their details are mentioned later, a terminal 112 provided in the main body 101 and a terminal 122 provided in the input/output unit 102 are configured to come into contact with each other when the main body 101 and the input/output unit 102 are overlapped with each other. One of the terminal 112 and the terminal 122 is configured to be concave and the other is configured to be convex, and they are configured such that a part of one of them is contained in the other.

The terminal 112 and the terminal 122 are configured to come into contact with each other, and thereby, a battery included in the input/output unit 102 is charged. Each of the main body 101 and the input/output unit 102 includes a battery therein and the main body 101 has a battery larger in capacity than the input/output unit 102 does.

Power that is expected in communication of the main body 101 and the input/output unit 102 with each other is supplied from the batteries built in the respective units. Therefore, when the volume of the battery of the input/output unit 102 decreases and the terminal 112 and the terminal 122 is in a connection state, power is configured to be supplied from the battery of the main body 101 to the battery of the input/output unit 102 to charge the battery of the input/output unit 102.

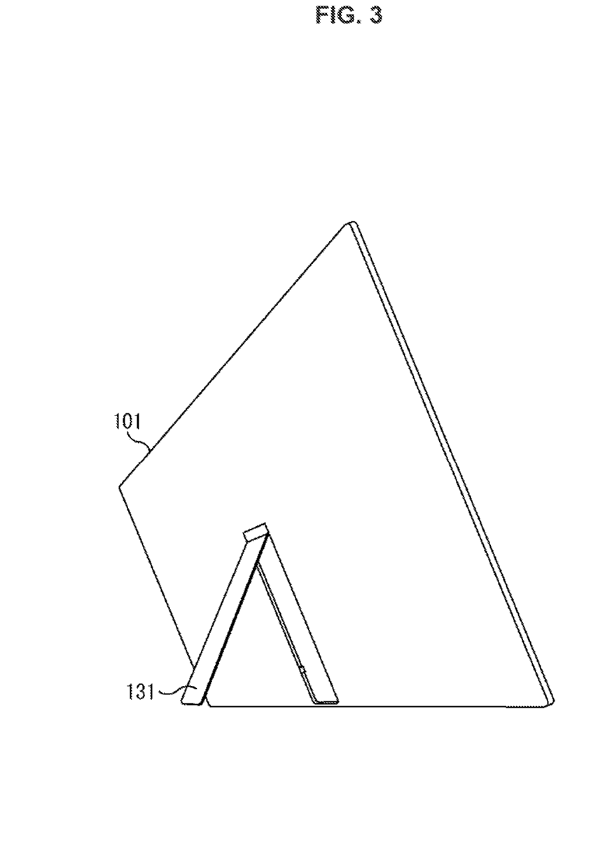

FIG. 2 is a diagram illustrating a configuration of a rear face of the information processing apparatus 100. A supporting part 131 is provided on the rear face of the main body 101. As mentioned later, the supporting part 131 is provided to be freely opened and closed with respect to the main body 101, FIG. 2 representing its closed state. As illustrated in FIG. 3, when the supporting part 131 is opened, the main body 101 is supported by the supporting part 131, this enabling the main body 101, for example, to be placed on a desktop at a predetermined angle for its usage.

For example, the user can manipulate the keyboard 121 of the input/output unit 102 to allow predetermined processing, looking at the display unit 111 thus placed on the desktop at the predetermined angle.

While a supporting part is not provided on the rear face of the input/output unit 102, such a supporting part can be configured to be provided, for example, when the input/output unit 102 is a loud speaker to be enabled to stand on the desktop at a predetermined angle.

Notably, while lateral faces of the information processing apparatus 100 are not shown, a memory card slot, USB terminal and the like, for example, are provided thereon.

### <Internal Configuration of Information Processing Apparatus>

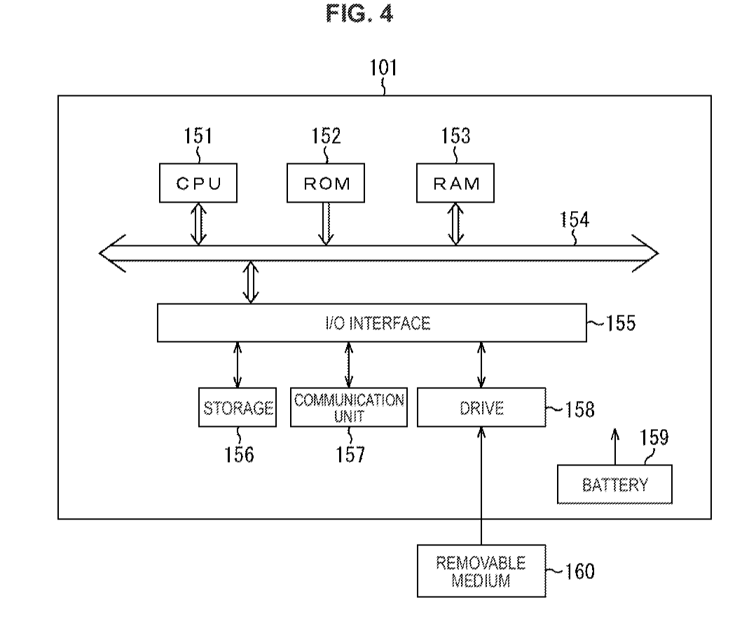

FIG. 4 is a block diagram illustrating an exemplary configuration of hardware of the main body 101 in the information processing apparatus 100. In the main body 101, a CPU (Central Processing Unit) 151, a ROM (Read Only Memory) 152 and a RAM (Random Access Memory) 153 are connected to one another via a bus 154. Furthermore, an I/O interface 155 is connected to the bus 154. A storage 156, a communication unit 157 and a drive 158 are connected to the I/O interface 155.

The main body 101 includes a battery 159 which supplies power expected in operation of the individual units of the main body 101. Moreover, the battery 159 is a secondary battery, being a rechargeable battery.

The storage 156 is constituted of a hard disk drive, a non-volatile memory and the like. The communication unit 157 is constituted of a network interface and the like. The description herein continues, supposing that the communication unit 157 communicates with the input/output unit 102. The drive 158 drives a removable medium 160 such as a magnetic disk, an optical disk, a magneto-optical disk, and a semiconductor memory.

Notably, an input unit is also provided in the main body 101 when a touch panel is attached to the display unit 111 of the main body 101 to enable data input.

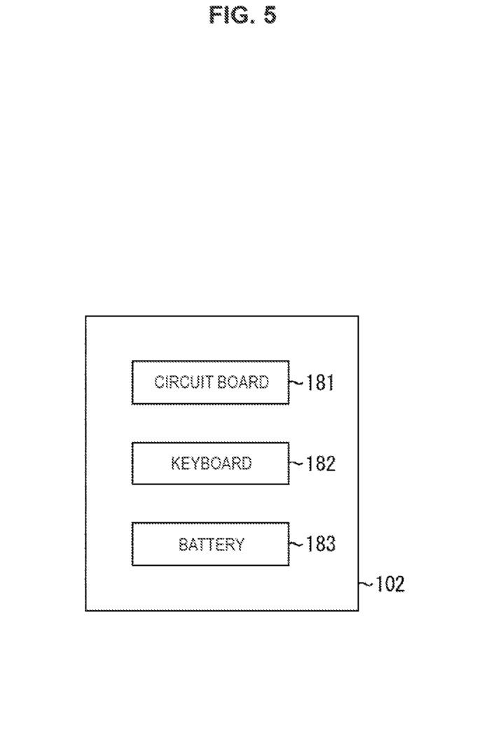

FIG. 5 is a block diagram illustrating an exemplary configuration of hardware of the input/output unit 102 in the information processing apparatus 100. The input/output unit 102 is configured to include a circuit board 181, a keyboard 182 and a battery 183. The circuit board 181 includes a communication unit which generates an operation signal in operation of the keyboard 182 and transmits it to the main body 101.

The battery 183 supplies power expected in operation of the individual units of the input/output unit 102. Moreover, the battery 183 is a secondary battery, being a rechargeable battery. Moreover, the description hereafter continues, supposing that the battery 183 of the input/output unit 102 is charged under reception of power supply from the battery 159 of the main body 101.

### <Overlapping for Information Processing Apparatus>

The main body 101 and the input/output unit 102 are configured to be able to be overlapped with each other and configured to have good portability when overlapped.

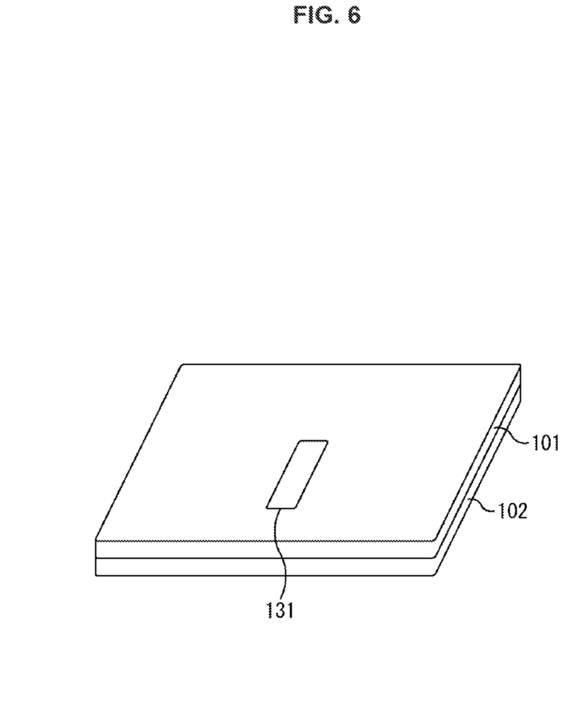

FIG. 6 is a diagram illustrating overlapping of the main body 101 and the input/output unit 102 with each other. FIG. 6 presents a state where the main body 101 is overlapped on the input/output unit 102. Moreover, in the state presented in FIG. 6, the display unit 111 of the main body 101 opposes the keyboard 121 of the input/output unit 102 for the overlapping. In such an overlapping state of the main body 101 and the input/output unit 102 with each other, they are readily portable like a notebook-type personal computer.

When the main body 101 and the input/output unit 102 are simply overlapped with each other, the main body 101 suffers displacement or the like relative to the input/output unit 102 to be unstable, this causing a possibility of less portability of those leading to dropping and breakage of those. Mechanisms will be described for locking the main body 101 and the input/output unit 102 to each other without the displacement or the like of the main body 101 and the input/output unit 102 out of each other when the main body 101 and the input/output unit 102 are overlapped with each other.

### <Locking Using Magnets>

The description is herein made for a configuration in which the main body 101 and the input/output unit 102 are locked to each other using force with which magnets attract each other when they are overlapped with each other.

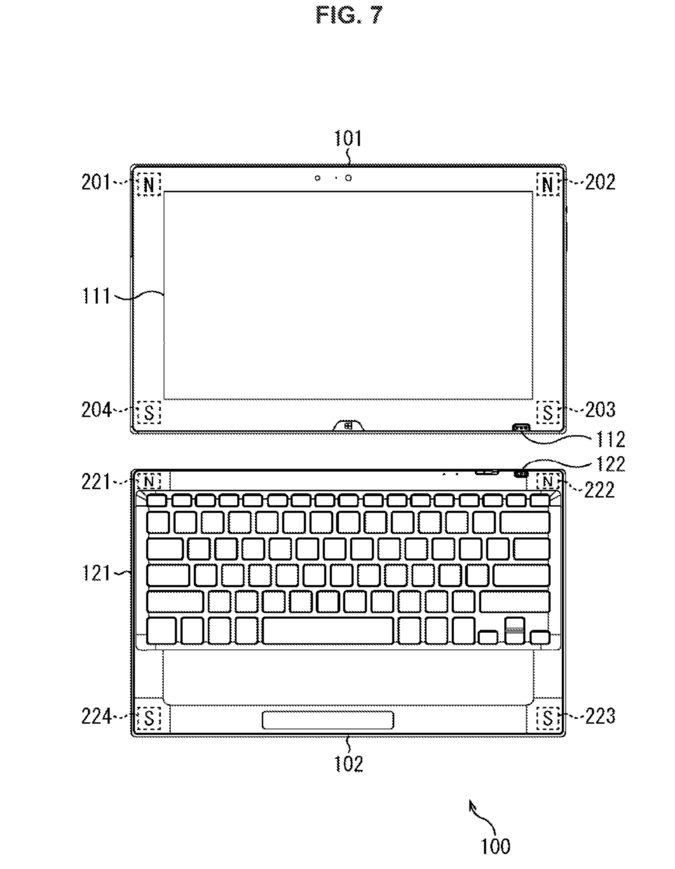

FIG. 7 is a diagram for explaining positional relation between magnets respectively provided in the main body 101 and the input/output unit 102. For the main body 101, magnets 201 to 204 are provided at the respective corners of the main body 101. The magnet 201 is provided in the upper left from the display unit 111, the magnet 202 is provided in the upper right from the display unit 111, the magnet 203 is provided in the lower right from the display unit 111 and the magnet 204 is provided in the lower left from the display unit 111.

Magnets are provided at the positions in the input/output unit 102 corresponding to the positions at which these magnets are arranged in the main body 101. At the corresponding positions, the magnets in the main body 101 and the input/output unit 102 are overlapped with each other when the main body 101 and the input/output unit 102 are overlapped with each other. A magnet 221 is provided in the upper left from the keyboard 121 of the input/output unit 102, a magnet 222 is provided in the upper right therefrom, a magnet 223 is provided in the lower right therefrom and a magnet 224 is provided in the lower left therefrom.

The magnets are provided in the main body 101 and the input/output unit 102 such that the poles of the magnets are positioned such that the magnets attract each other when the main body 101 and the input/output unit 102 are overlapped with each other.

Assuming that the main body 101 and the input/output unit 102 should be maintained to be attached to each other with no displacement in positional relation therebetween simply when they have been overlapped with each other, it is sufficient that the magnets 201 to 204 of the main body 101 all show the same poles on the display unit 111 face side and that the magnets 221 to 224 of the input/output unit 102 all have the other same poles on the keyboard 121 face side to show these different poles from those of the magnet 201 to 204.

For example, the magnets 201 to 204 are provided such that the magnets 201 to 204 show their N-poles on the display unit 111 face side of the main body 101. The magnets 221 to 224 are provided such that the magnets 221 to 224 show their S-poles on the keyboard 121 face side of the input/output unit 102.

In the case of such a configuration, the magnets 201 to 204 and the magnets 221 to 224 are put in the relation where the magnets opposite to each other attract each other when the main body 101 and the input/output unit 102 are overlapped with each other. Therefore, the main body 101 and the input/output unit 102 can be maintained to be attached to each other with no displacement in positional relation between the main body 101 and the input/output unit 102 when they are overlapped with each other, due to the force with which the magnets attract each other.

As mentioned above, the information processing apparatus 100 has the terminal 112 and the terminal 122 and has the function for causing the battery 159 of the main body 101 to supply power and charging the battery 183 of the input/output unit 102 under the power supply when the main body 101 and the input/output unit 102 are overlapped with each other. For the purpose, the terminal 112 and the terminal 122 should be correctly connected to each other when the main body 101 and the input/output unit 102 are overlapped with each other.

Moreover, as mentioned later, in the case of a configuration of contactless charging without the terminal 112 or the terminal 122 provided, if portions for the contactless charging are not overlapped with each other when the main body 101 and the input/output unit 102 are overlapped with each other, the charging becomes to be difficult. In other words, in a case of overlapping in a wrong orientation when the main body 101 and the input/output unit 102 are overlapped with each other, the charging becomes to be difficult.

As above, portions in relation to charging should be correctly overlapped with each other for the charging. Therefore, the magnets are arranged such that at least one of them has a different pole from those of the others on the same face, for the main body 101 and the input/output unit 102 overlapped with each other in the correct orientation. FIG. 7 exemplarily illustrates an arrangement in which two of four magnets on the same face have different poles from those of the others.

Referring to FIG. 7, the magnet 201 and the magnet 202 are arranged such that they show their N-poles on the face on which the display unit 111 of the main body 101 is provided, and the magnet 203 and the magnet 204 are arranged such that they show their S-poles thereon. Similarly, the magnet 221 and the magnet 222 are arranged such that they show their S-poles on the face on which the keyboard 121 of the input/output unit 102 is provided, and the magnet 223 and the magnet 224 are arranged such that they show their N-poles thereon.

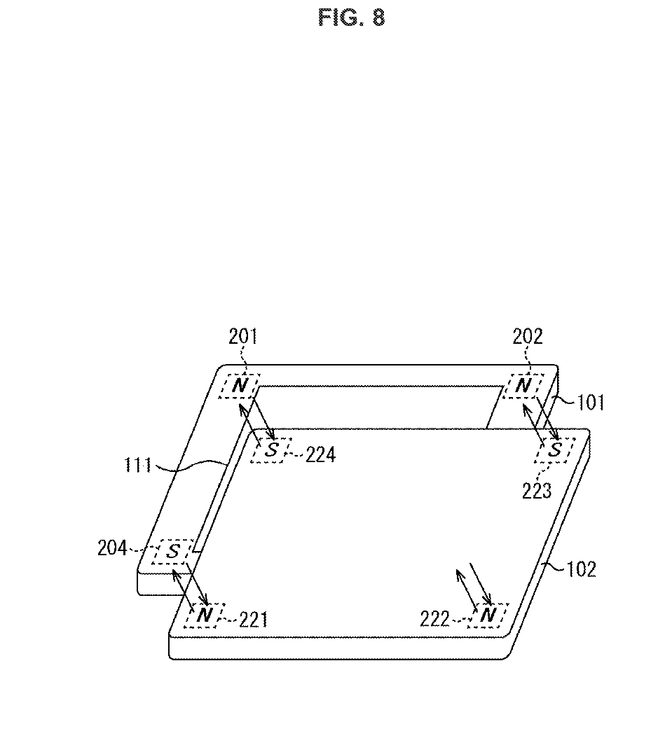

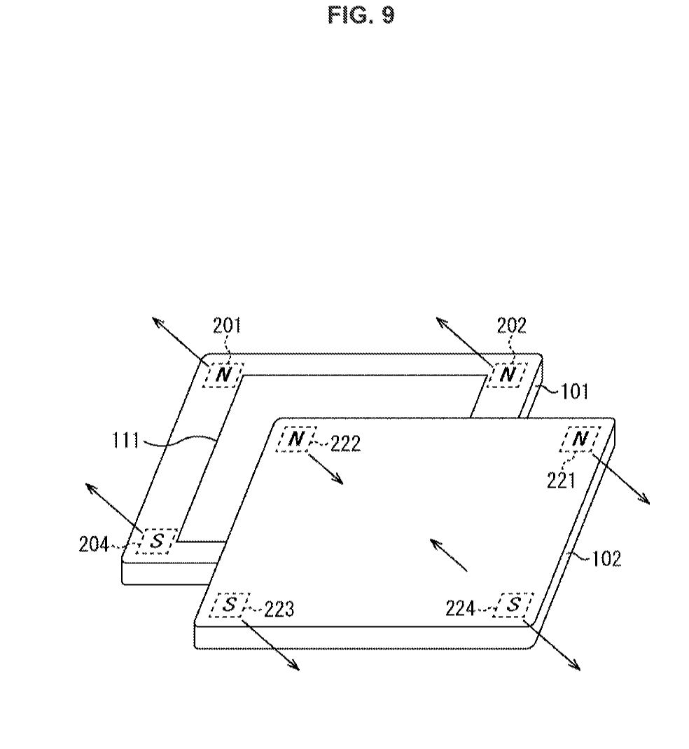

In such an arrangement of the magnets, overlapping in the correct orientation is represented by a state as illustrated in FIG. 8 and overlapping in a wrong orientation is represented by a state as illustrated in FIG. 9. First, the overlapping in the correct orientation is described with reference to FIG. 8.

When the main body 101 and the input/output unit 102 are overlapped with each other in the correct orientation, the N-pole of the magnet 201 of the main body 101 and the S-pole of the magnet 224 of the input/output unit 102 attract each other and the N-pole of the magnet 202 of the main body 101 and the S-pole of the magnet 223 of the input/output unit 102 attract each other. Similarly, the S-pole of the magnet 203 (not shown in FIG. 8) of the main body 101 and the N-pole of the magnet 222 of the input/output unit 102 attract each other and the S-pole of the magnet 204 of the main body 101 and the N-pole of the magnet 221 of the input/output unit 102 attract each other.

As above, when the main body 101 and the input/output unit 102 are overlapped with each other in the correct orientation, the magnets of the main body 101 and the input/output unit 102 attract each other. The user can overlap the main body 101 and the input/output unit 102 with each other in the correct orientation by slidingly moving, for example, the input/output unit 102 on the main body 101 in accordance with such attracting force.

When the main body 101 and the input/output unit 102 have been overlapped with each other in this way, the terminal 112 and the terminal 122 come into contact with each other to be chargeable. Moreover, the main body 101 and the input/output unit 102 are maintained to be overlapped with each other due to the force with which the magnets attract each other. Namely, the main body 101 and the input/output unit 102 are maintained to be locked to each other.

Notably, the correct orientation means an orientation in which the force with which the magnets attract each other arises and an orientation in which the main body 101 or the input/output unit 102 is moved for the terminal 112 and the terminal 122 allowed to come into contact with each other as mentioned above.

Moreover, the correct orientation means an orientation in which the display unit 111 and the keyboard 121 are contained inside the information processing apparatus 100 and are not visually seen by the user when the display unit 111 of the main body 101 and the keyboard 121 of the input/output unit 102 oppose each other, in other words, the main body 101 and the input/output unit 102 are overlapped with each other.

Moreover, the correct orientation means an orientation in which the upper side of the main body 101 and the lower side of the input/output unit 102 are overlapped with each other and the lower side of the main body 101 and the upper side of the input/output unit 102 are overlapped with each other in the information processing apparatus 100 illustrated in FIG. 7. When the information processing apparatus 100 is placed as in FIG. 7, in the correct orientation, the input/output unit 102 is held up and vertically reversed upside down to be overlapped with the main body 101.

Notably, the correct orientation is mentioned above by way of example since it is determined depending on the arrangement of the magnets and the terminals 112 and 122.

Orientations in cases other than the above, which are not correct, are wrong orientations. When the main body 101 and the input/output unit 102 are being overlapped with each other in such a wrong orientation, their state becomes as in FIG. 9. The N-pole of the magnet 201 of the main body 101 and the N-pole of the magnet 222 of the input/output unit 102 repel each other and the N-pole of the magnet 202 of the main body 101 and the N-pole of the magnet 221 of the input/output unit 102 repel each other. Similarly, the S-pole of the magnet 203 (not shown in FIG. 9) of the main body 101 and the S-pole of the magnet 224 of the input/output unit 102 repel each other and the S-pole of the magnet 204 of the main body 101 and the S-pole of the magnet 223 of the input/output unit 102 repel each other.

As above, when the main body 101 and the input/output unit 102 are overlapped with each other in a wrong orientation, the magnets of the main body 101 and the input/output unit 102 repel each other. The user can feel such repulsive force and recognize that the main body 101 and the input/output unit 102 are being overlapped with each other in the wrong orientation. Thus, the user can change the orientation, for example, of the input/output unit 102 in order to perform the overlapping in the correct orientation.

When the main body 101 and the input/output unit 102 are overlapped with each other in the wrong state as above, the terminal 112 and the terminal 122 do not come into contact with each other, therefore, not to be chargeable. This, however, can be prevented since the repulsive force between the magnets as mentioned above allows the user to recognize that the main body 101 and the input/output unit 102 are being overlapped with each other in the wrong orientation.

Moreover, after the main body 101 and the input/output unit 102 are overlapped with each other, the main body 101 and the input/output unit 102 can be maintained to be locked to each other due to the force with which the magnets attract each other.

Notably, the N-poles are herein exemplarily arranged in the upper portion of the main body 101 and the S-poles in the lower portion thereof as illustrated in FIG. 7, for example, whereas the S-poles may be arranged in the upper portion thereof and the N-poles be in the lower portion thereof. Moreover, the same poles may be arranged in the vertical direction. For example, the magnet 201 and the magnet 204 of the main body 101 may be the N-poles and the magnet 202 and the magnet 203 thereof be the S-poles.

Moreover, only one of the four magnets may be the different pole, for example. The magnets 201 to 203 of the main body 101 may be N-poles and the magnet 204 be an S-pole, for example. The poles of the magnets 221 to 224 of the input/output unit 102 are simply determined so as to match the poles of the magnets of the main body 101. Moreover, any of the above arrangements regarding the poles of the magnets of the main body 101 meets the configuration in which the force with which the magnets attract each other can be exerted on the main body 101 and the input/output unit 102 as mentioned above when they are being overlapped with each other in the correct orientation, this guiding the overlapping to the correct orientation.

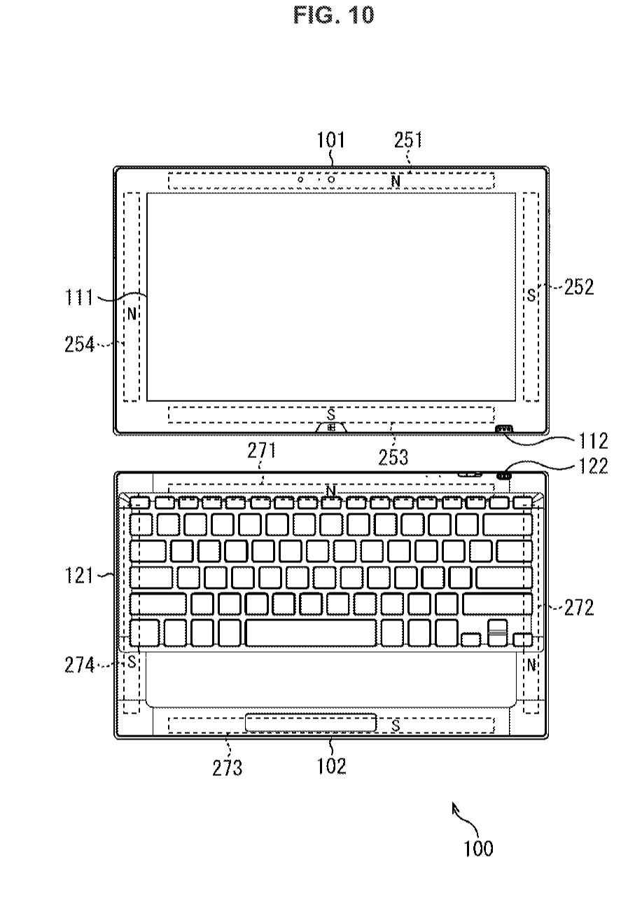

Notably, the arrangement of the four magnets at the respective corners of the main body 101 and the input/output unit 102 is herein presented by way of example as illustrated in FIG. 7, whereas they may be provided on the sides of the main body 101 and the input/output unit 102. For example, magnets may be arranged on the sides of the main body 101 and the input/output unit 102 as illustrated in FIG. 10.

Referring to FIG. 10, a magnet 251 is provided on the upper side of the main body 101, a magnet 252 is provided on the right side thereof, a magnet 253 is provided on the lower side thereof and a magnet 254 is provided on the left side thereof. Moreover, the magnets show an N-pole, an S-pole, an S-pole and an N-pole in the order of the magnet 251, the magnet 252, the magnet 253 and the magnet 254 on the face side on which the display unit 111 is provided. This arrangement is exemplary and is not described for any limitation. Moreover, the dimensions and shapes of the magnets are also exemplary and are not described for any limitation. This applies in the following description.

Magnets are provided at the positions of the input/output unit 102 corresponding to the arrangement of those magnets. In the example of FIG. 10, a magnet 271 is provided on the upper side of the input/output unit 102, a magnet 272 is provided on the right side thereof, a magnet 273 is provided on the lower side thereof and a magnet 274 is provided on the left side thereof. Moreover, the magnets show an N-pole, an N-pole, an S-pole and an S-pole in the order of the magnet 271, the magnet 272, the magnet 273 and the magnet 274 on the face side on which the keyboard 121 is provided.

Such an arrangement of the magnets of the main body 101 and the input/output unit 102 can still meet the configuration in which the force with which the magnets attract each other can be exerted on the main body 101 and the input/output unit 102 as mentioned above when they are being overlapped with each other in the correct orientation, this guiding the overlapping to the correct orientation.

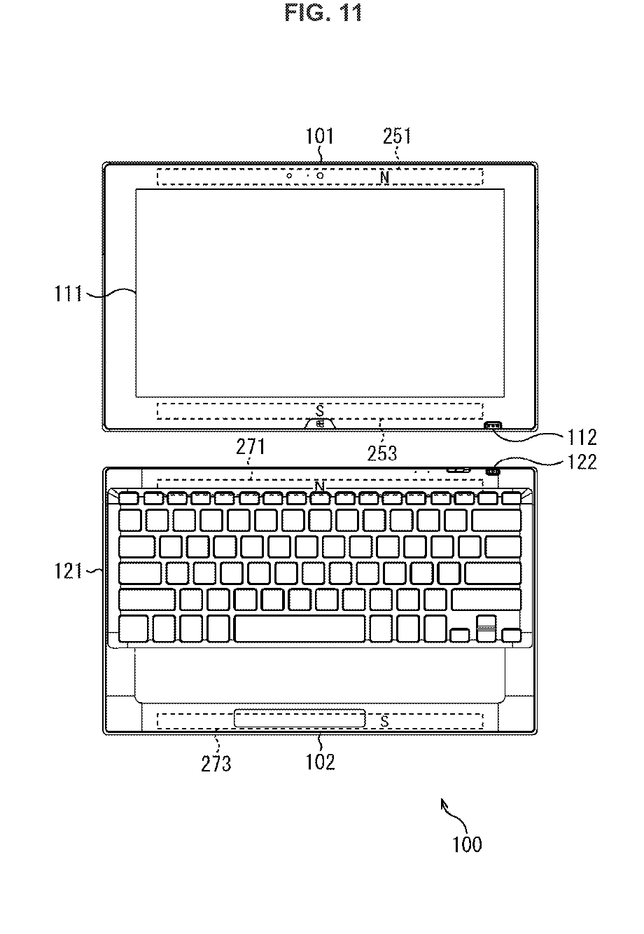

Notably, the arrangement of the four magnets in each of the main body 101 and the input/output unit 102 is herein presented by way of example as illustrated in FIG. 7 and FIG. 10, whereas the description is made not for limiting the number of the magnets to four. For example, the number of the magnets may be two as illustrated in FIG. 11.

Referring to FIG. 11, a magnet 251 and a magnet 253 are provided in the main body 101. Moreover, a magnet 271 and a magnet 273 are provided in the input/output unit 102. The main body 101 illustrated in FIG. 11 has a configuration led by eliminating the magnet 252 and the magnet 254 from the main body 101 illustrated in FIG. 10. The input/output unit 102 similarly has a configuration led by eliminating the magnet 272 and the magnet 274 from the input/output unit 102 illustrated in FIG. 10.

FIG. 11 represents the magnets provided along the long sides by way of example, whereas they may also be provided along the short sides. Not shown in the figures, it is possible that the main body 101 has the magnet 252 and the magnet 254 of the main body 101 illustrated in FIG. 10 and the input/output unit 102 has the magnet 272 and the magnet 274 of the input/output unit 102 illustrated in FIG. 10.

Not shown in the figures, when each of the main body 101 and the input/output unit 102 is configured to have two magnets, the main body 101 may have one magnet on the long side and one magnet on the short side, magnets provided at the positions of the input/output unit 102 corresponding to those magnets. For example, a configuration is possible in which the main body 101 has the magnet 251 and the magnet 252 (FIG. 10) and the input/output unit 102 has the magnet 271 and the magnet 22.

Any of the above configurations in which each of the main body 101 and the input/output unit 102 has two magnets can still meet the configuration in which the force with which the magnets attract each other is exerted on the main body 101 and the input/output unit 102 as mentioned above when they are being overlapped with each other in the correct orientation, this guiding the overlapping to the correct orientation.

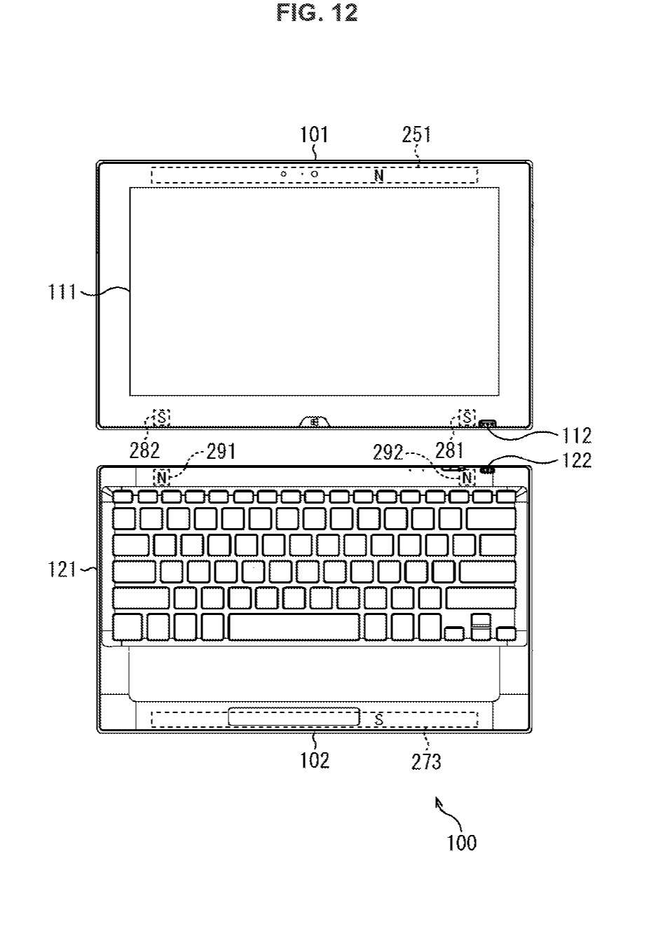

Furthermore, the number of the magnets provided in each of the main body 101 and the input/output unit 102 may be three. For example, as illustrated in FIG. 12, the main body 101 is provided with the magnet 251, a magnet 281 and a magnet 282. The magnet 251 is same as the magnet 251 illustrated in FIG. 11, provided on the upper side of the main body 101 and arranged to show the N-pole on the face on which the display unit 111 is provided. The magnet 281 and the magnet 282 are provided at the corners on the lower side of the main body 101 equivalently to the magnet 203 and the magnet 204 illustrated in FIG. 7.

Similarly, the input/output unit 102 is provided with the magnet 273, a magnet 291 and a magnet 292. The magnet 273 is same as the magnet 273 illustrated in FIG. 11, provided on the lower side of the input/output unit 102 and arranged to show the S-pole on the face on which the keyboard 121 is provided. The magnet 291 and the magnet 292 are provided at the corners on the upper side of the input/output unit 102 equivalently to the magnet 221 and the magnet 222 illustrated in FIG. 7.

The above configuration in which each of the main body 101 and the input/output unit 102 has three magnets can still meet a configuration in which the force with which the magnets attract each other is exerted on the main body 101 and the input/output unit 102 as mentioned above when the main body 101 and the input/output unit 102 are overlapped with each other in the correct orientation, this guiding the overlapping to the correct orientation.

Moreover, not shown in the figures, the number of the magnets arranged in each of the main body 101 and the input/output unit 102 may be one. The force with which the magnets attract each other is exerted on the main body 101 and the input/output unit 102 due to one magnet included in the main body 101 and one magnet included in the input/output unit 102, when they are overlapped with each other in the correct orientation.

The force with which the magnets attract each other is not exerted on the main body 101 and the input/output unit 102 when they are overlapped with each other in a wrong orientation. The user recognizes that the main body 101 is difficult to be attached to the input/output unit 102 and makes the attachment in the correct orientation. Therefore, still in this case, the force with which the magnets attract each other is exerted on the main body 101 and the input/output unit 102 when they are overlapped with each other in the correct orientation, this guiding the overlapping to the correct orientation.

However, when the number of the magnets arranged in each of the main body 101 and the input/output unit 102 is one, there is a possibility that locking of the main body 101 and the input/output unit 102 to each other is unstable. Therefore, a configuration may be provided, for example, in which the terminal 112 and the terminal 122 are engaged with each other, this enabling a mechanism for locking the main body 101 and the input/output unit 102 to each other by means of the engagement of the terminal 112 and the terminal 122 with each other and the force with which the magnets attract each other.

Notably, not shown in the figures, a configuration is possible of including five or more magnets. Taking account of the arrangement and the like of the magnets, such a configuration can be enabled to meet the configuration in which the force with which the magnets attract each other is exerted on the main body 101 and the input/output unit 102 when they are overlapped with each other in the correct orientation, this guiding the overlapping to the correct orientation.

In the above-mentioned embodiments, the main body 101 and the input/output unit 102 have the same number of magnets by way of example, whereas they can include the different numbers of magnets. For example, in the example of FIG. 12, the input/output unit 102 may have one magnet into which the magnet 291 and the magnet 292 are integrated to be a long and thin magnet along the side like the magnet 273. In this case, the main body 101 is to have three magnets and the input/output unit 102 is to have two magnets, giving the configuration in which the main body 101 and the input/output unit 102 include the different numbers of magnets.

The above description has been made by way of examples and it is sufficient that the number, arrangement and dimensions of the magnets allow the configuration in which the force with which the magnets attract each other is exerted on the main body 101 and the input/output unit 102 when they are overlapped with each other in the correct orientation, this guiding the overlapping to the correct orientation.

Notably, when any portion which is possibly affected by the magnetic force is in the main body 101 and/or the input/output unit 102, for example, when a port or the like through which contactless transfer of data is performed is possibly affected by the magnetic force, the port and the magnets are arranged to be as apart from each other as possible or a member for shielding the magnetic force is arranged between the port and the magnets such that the port is not affected by the magnetic force.

### <Configuration of Terminals>

Furthermore, in this embodiment, the terminal 112 and the terminal 122 provide a configuration to enable positioning for overlapping the main body 101 and the input/output unit 102 with each other at the correct position. These terminal 112 and the terminal 122 will be additionally described.

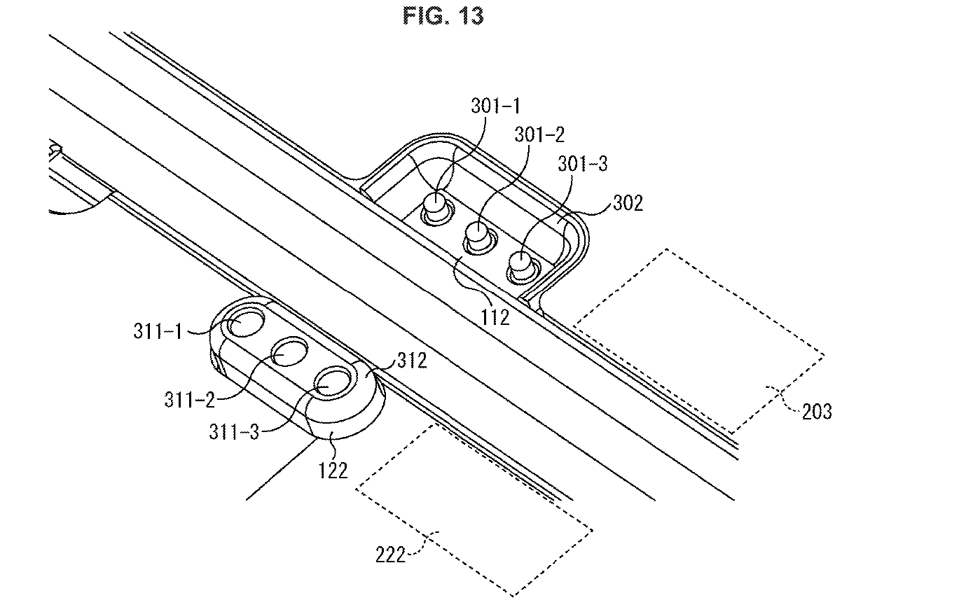

FIG. 13 is an enlarged view of portions of the terminal 112 and the terminal 122. The terminal 112 is configured to be concave and is provided as a terminal for supplying power to the terminal 122 side. The terminal 122 is configured to be convex and is provided as a terminal for receiving the power supply from the terminal 112. They are configured to contain the convex terminal 122 in the concave terminal 112. The terminal 112 has three pins 301-1 to 301-3 and the terminal 122 is provided with pads 311-1 to 311-3 at the positions for receiving the three pins 301.

When the pins 301 and the pads 311 are in a contact state, charging is performed as necessary. The pin 301-1 and the pin 301-3 are a negative pin and a positive pin for power supply and the pin 301-2 is a pin for detecting full charging of the battery 183 (FIG. 3) of the keyboard 121. The charging is performed according to the volume of the battery 183 detected through the pin 301-2.

For example, the charging is performed when the state where the pins 301 are brought into contact with the pads 311 is detected and the remaining volume of the battery 183 is detected to be below 50% through the pin 301-2.

The charging with the pins 301 and the pads 311 brought into contact with each other as above is called contact charging. As mentioned later, charging without the pins 301 and the pads 311 as above is called contactless charging.

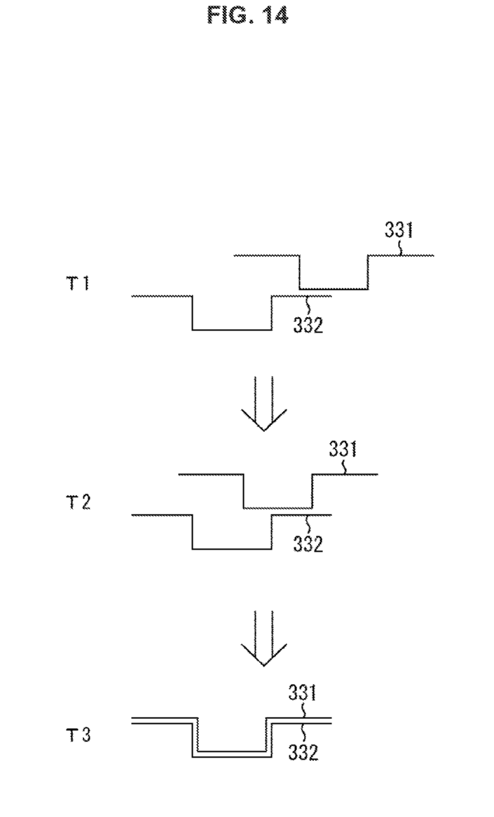

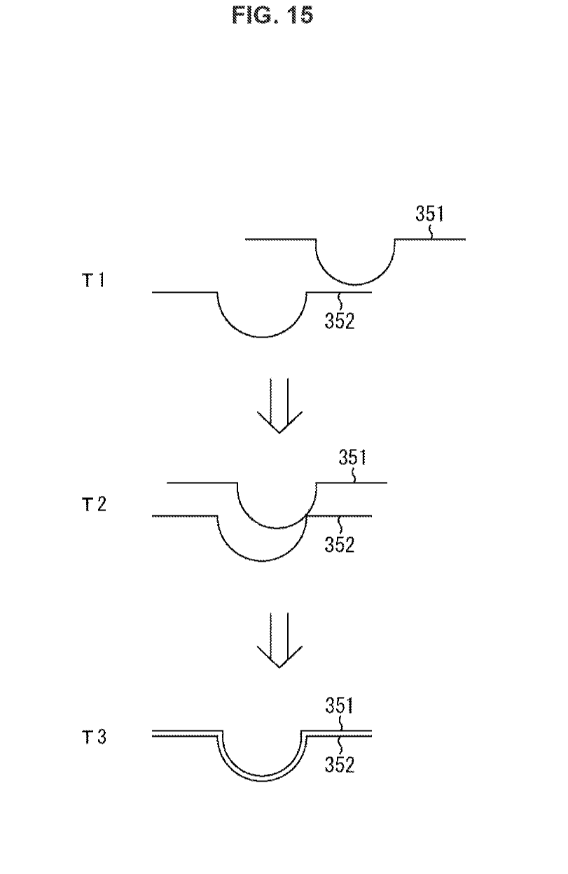

Referring to FIG. 13, a lateral face of the terminal 112 has a curved surface 302 and a lateral face of the terminal 122 also has a curved surface 312. The configuration in which the curved surfaces are included allows the terminal 112 to be introduced (to be readily contained) into the terminal 122. The reason is explained with reference to FIG. 14 and FIG. 15.

A case is considered where rectangular concave part 331 and concave part 332 not having any curved surface are being overlapped with each other as illustrated in FIG. 14. At time T1, while the concave part 331 is on the concave part 332, it is not positioned at the concave portion. From such a state, the concave part 331 is gradually being moved slidingly on the concave part 332 to the left in the figure.

At time T2, although a half of the concave part 331 is positioned at the concave portion of the concave part 332, they are still difficult to be overlapped just on and with each other. Furthermore, sliding the concave part 331 to the left, at time T3, the concave portion of the concave part 331 is positioned completely at the concave portion of the concave part 332. In this stage, the concave portion of the concave part 331 is contained in the concave portion of the concave part 332, they overlapped with each other.

As above, in the case of the rectangular concave parts, when one concave portion is positioned completely at the other concave portion, the one concave part is contained in the other concave part. Assuming that the user is sliding the concave part 331, he/she feels a sudden drop of the concave part 331 into the concave part 332. If such rectangular shapes are applied to the terminal 112 and the terminal 122, the terminal 122 is to drop into the terminal 112 suddenly, this not attaining the introduction of the terminal 112 into the terminal 122 for overlapping the terminal 112 and the terminal 122 with each other.

On the contrary, in the case of the concave parts having curved surfaces as illustrated in FIG. 15, the terminal 122 can be prevented from dropping into the terminal 112 suddenly and allowed to be introduced thereinto for overlapping. Referring to FIG. 15, overlapping a concave part 351 and a concave part 352 constituted of curved surfaces with each other is considered.

At time T1, while the concave part 351 is on the concave part 352, it is not positioned at the curved surface portion. From such a state, the concave part 351 is gradually being moved slidingly on the concave part 352 to the left in the figure.

At time T2, a half of the concave part 351 is positioned at the curved surface portion of the concave part 352. Since the concave part 351 is constituted of the curved surface, a part of the concave part 351 is contained in the concave part 352. Furthermore, sliding the concave part 351 to the left, at time T3, the curved surface portion of the concave part 351 is positioned completely at the curved surface portion of the concave part 352. In this stage, the curved surface portion of the concave part 351 is completely contained in the concave part 352, they overlapped with each other.

As above, in the case of the curved surfaces, one curved surface portion is gradually being contained in the other curved surface portion. Assuming that the user is sliding the concave part 351, he/she feels gradual dropping of the concave part 351 into the concave part 352. When such curved surface shapes are applied to the terminal 112 and the terminal 122, the terminal 122 is to be dropping gradually into the terminal 112, this attaining the introduction of the terminal 112 into the terminal 122 for overlapping the terminal 112 and the terminal 122 with each other.

Therefore, as illustrated in FIG. 13, the curved surface 302 is provided on the lateral face of the terminal 112 and the curved surface 312 is provided on the lateral face of the terminal 122. Providing the curved surface 302 and the curved surface 312 affords the same effect as in the case of the concave part 351 and the concave part 352 formed of the curved surfaces illustrated in FIG. 15, allowing the terminal 122 to be dropping gradually into the terminal 112 and allowing the introduction of the terminal 112 into the terminal 122 for overlapping the terminal 112 and the terminal 122 with each other.

As above, the terminal 112 and the terminal 122 can play roles of positioning the main body 101 and the input/output unit 102 when they are overlapped with each other in the correct orientation and allowing the main body 101 and the input/output unit 102 to be readily overlapped with each other.

The terminal 112 and the terminal 122 may be configured to be engaged with each other. The main body 101 and the input/output unit 102 can be additionally locked to each other by the terminal 112 and the terminal 122 engaged with each other when they are overlapped with each other, in addition to the locking with the magnets, this more securely allow the main body 101 and the input/output unit 102 to be locked to each other.

Moreover, providing the terminal 112 and the terminal 122 can prevent positional displacement between the main body 101 and the input/output unit 102. The main body 101 and the input/output unit 102 are fixed to each other due to the force between the magnet 203 and the magnet 222 when the main body 101 and the input/output unit 102 are overlapped with each other.

Force exerted on the input/output unit 102 when the input/output unit 102 is detached off in the state where the main body 101 and the input/output unit 102 are overlapped with each other is different in the horizontal direction or in the vertical direction. Namely, the configuration is made such that the force is stronger in the vertical direction and the force is weaker in the horizontal direction. This is because the input/output unit 102 can be configured to be detached from the main body 101 by sliding the input/output unit 102 in the horizontal direction relative to the main body 101, and then, holding it up in the vertical direction.

However, when the input/output unit 102 is configured to be able to be detached slidingly from main body 101 even with weak force exerted in the horizontal direction, there can be a risk that the input/output unit 102 suffers positional displacement relative to the main body 101 in the horizontal direction.

In order to configure the input/output unit 102 not to suffer positional displacement relative to the main body 101, it can be thought that the magnetic force of the magnet 203 and the magnet 222 is made stronger, this allowing the force in the horizontal direction to be stronger. Nevertheless, when the magnetic force of the magnet 203 and the magnet 222 is made stronger, the input/output unit 102 is harder to be slid relative to the main body 101 and the input/output unit 102 is harder to be detached off when the input/output unit 102 is to be detached from the main body 101, this possibly cause less usability.

On the contrary, providing the terminal 112 and the terminal 122 enables the terminal 112 and the terminal 122 to accept the force exerted in the horizontal direction and enables the positional displacement between the main body 101 and the input/output unit 102 to be prevented. Moreover, providing the terminal 112 and the terminal 122 also enables the main body 101 and the input/output unit 102 to be positioned in order to overlap them with each other in the correct orientation as mentioned above.

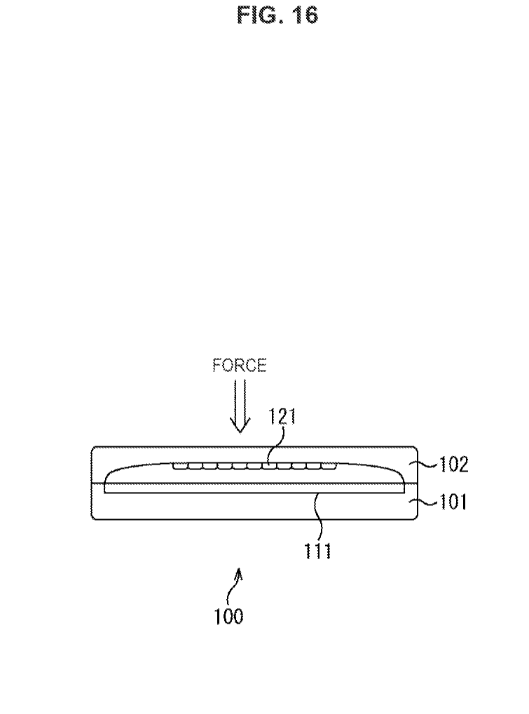

By the way, when the main body 101 and the input/output unit 102 are overlapped with each other, as illustrated in FIG. 16, the display unit 111 of the main body 101 and the keyboard 121 of the input/output unit 102 are enclosed in the information processing apparatus 100. Here, it is supposed that force is applied downward onto the information processing apparatus 100 as illustrated in FIG. 16 when the main body 101 and the input/output unit 102 are overlapped with each other.

In such a case, the keyboard 121 possibly comes into contact with the display unit 111. If the keyboard 121 is brought into contact with the display unit 111, inconvenience can arise, for example, the display unit 111 can suffer scratches. In order to prevent such inconvenience from arising, as illustrated in FIG. 16, the display unit 111 and the keyboard 121 are configured to have a space between them.

In the example of FIG. 16, the portion in which the keyboard 121 is provided is configured to correspond to a depressed portion in the input/output unit 102. In other words, the portion in which the keyboard 121 is provided is configured to be below the edge portion of the input/output unit 102. While FIG. 16 illustrates a large space for explanation, this may be a depression which the user does not recognize (is not conscious for) in reality. Moreover, it can be formed into a mortar shape. Moreover, the portion in which the display unit 111 is provided may be configured to be a depression.

As above, providing a space between the display unit 111 and the keyboard 121 can prevent the display unit 111 from coming into contact with the keyboard 121 when the force is applied onto the information processing apparatus 100. Moreover, even when the display unit 111 comes into contact with the keyboard 121, the impact caused by such contact can be reduced.

### <Contactless Charging>

In the above-mentioned embodiment, contact charging with the terminal 112 and the terminal 122 provided is exemplarily described. Contactless charging is herein exemplarily described.

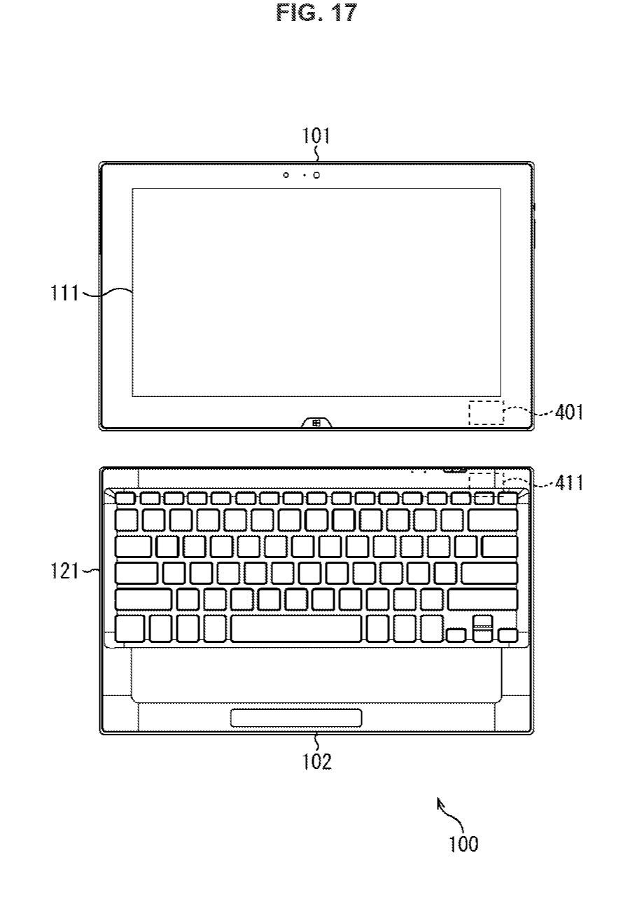

FIG. 17 illustrates a configuration of appearance of the information processing apparatus 100 in the contactless charging. Namely, the terminal 112 and the terminal 122 are not provided, and in those portions, a power supplying unit 401 and a power receiving unit 411 for contactless charging are provided instead.

The power supplying unit 401 is provided in the main body 101 and the power receiving unit 411 is provided in the input/output unit 102. The power supplying unit 401 and the power receiving unit 411 are provided at positions which overlap with each other when the main body 101 and the input/output unit 102 are overlapped with each other. The power supplying unit 401 and the power receiving unit 411 are configured to be built in the main body 101 and the input/output unit 102, respectively, and thus, not to visually seen by the user.

Same as in the above-mentioned embodiment, also in the case of contactless charging, the main body 101 and the input/output unit 102 are configured to be able to be overlapped with each other in the correct orientation due to the repulsive force and the attractive force of the magnets by the user. Therefore, when the main body 101 and the input/output unit 102 are overlapped with each other, the power supplying unit 401 and the power receiving unit 411 are also overlapped with each other.

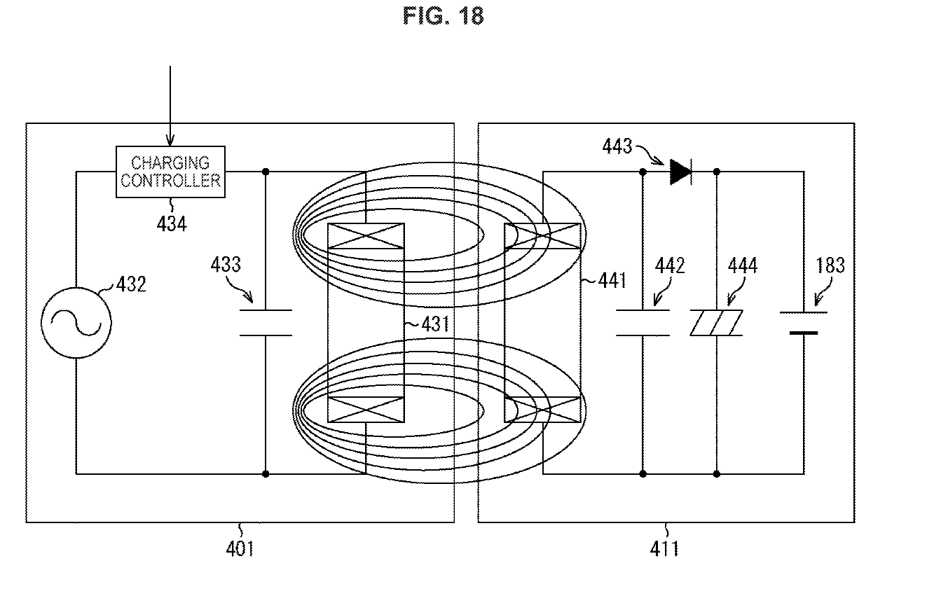

FIG. 18 is a diagram illustrating configurations of the power supplying unit 401 and the power receiving unit 411. The power supplying unit 401 includes a coil 431, a power supply 432, a capacitor 433 and a charging controller 434. The capacitor 433 is a capacitor for resonance and supplies power from the power supply 432 to the coil 431.

The charging controller 434 controls the charging. The charging controller 434 starts the charging (power supply) when detecting, for example, overlapping of the main body 101 and the input/output unit 102 with each other and detecting that the volume of the battery 183 on the input/output unit 102 side is equal to or smaller than a predetermined volume.

The power receiving unit 411 of the input/output unit 102 includes a coil 441, a capacitor 442, a diode 443, a capacitor 444 and a battery 183. The capacitor 442 is a capacitor for resonance. The diode 443 is a diode for rectifying the induced voltage generated in the coil 441. Moreover, the capacitor 444 is a capacitor for smoothing the induced voltage generated in the coil 441. The battery 183 is a rechargeable battery charged through these circuits and is, for example, a lithium ion battery, a nickel-metal hydride battery or the like.

The information processing apparatus 100 can be simply configured to be one for the above-mentioned contact charging similarly except that the charging is performed by overlapping the power supplying unit 401 and the power receiving unit 411 which have such configurations with each other. For example, the arrangements and the like of the magnets can be similar to the configurations mentioned above. Same as the above, the force with which the magnets attract each other is exerted on the main body 101 and the input/output unit 102 when they are overlapped with each other in the correct orientation, this guiding the overlapping to the correct orientation. Therefore, its description is omitted.

By the way, in the case of the charging in a contactless manner, the main body 101 and the input/output unit 102 are configured not to include the terminal 112 and the terminal 122 (FIG. 1) as illustrated in FIG. 17. As mentioned above, the main body 101 and the input/output unit 102 possibly suffer displacement of the input/output unit 102 relative to the main body 101. In the case of the terminal 112 and the terminal 122 included, these terminals can prevent the positional displacement from arising and also afford the function of positioning for overlapping in the correct orientation, this having been already described.

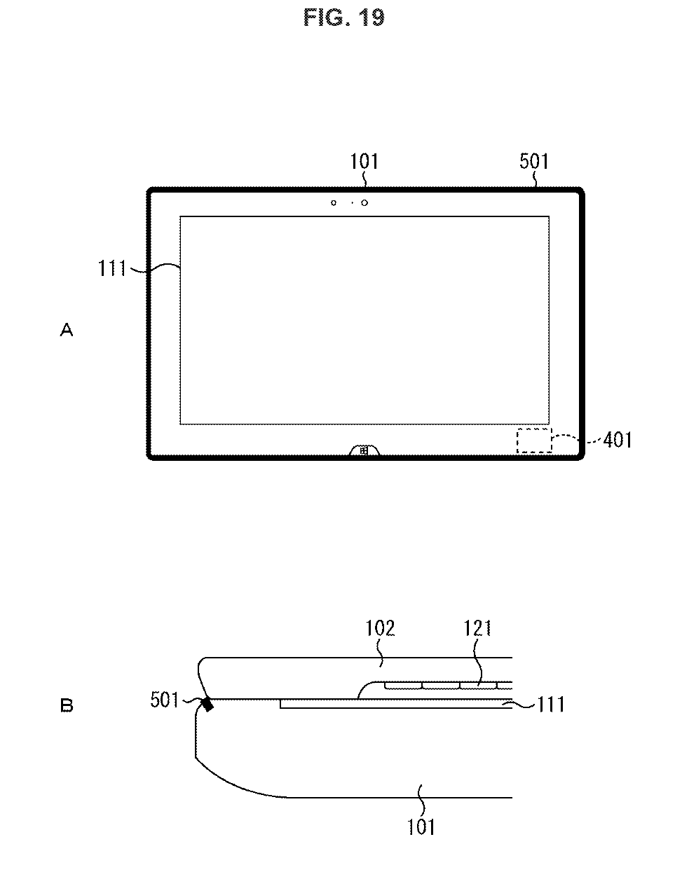

On the other hand, in the case of the contactless charging, in place of the terminal 112 and the terminal 122, it is desirable to provide a function of preventing the positional displacement and performing the positioning. Therefore, a configuration as illustrated in FIGS. 19A and 19B provides prevention of the positional displacement and positioning.

FIG. 19A is a diagram illustrating a configuration of appearance of the main body 101 configured to performing the contactless charging same as the main body 101 illustrated in FIG. 17. A relief is provided in an outer circumferential portion of the display unit 111 of the main body 101. Herein, a relief 501 is provided as a portion indicated by the thick line in FIG. 19A. The relief 501 is formed into a step shape and configured to protrude with respect to the display plane of the display unit 111 as illustrated in FIG. 19B.

FIG. 19B is a cross-sectional view of the main body 101 and the input/output unit 102 which are overlapped with each other. The relief 501 is provided in the outer circumferential portion of the display unit 111 such that, the display plane being the reference, the uppermost level of the relief 501 is at a level higher than the reference level. Moreover, it is provided also to be in a part outside the input/output unit 102 when the input/output unit 102 main body 101 are overlapped with each other.

Assuming that force is applied, as illustrated in FIG. 19B, in the horizontal direction (direction of the arrow in the figure) when the main body 101 and the input/output unit 102 are overlapped with each other, providing such a relief 501 enables the force to be accepted by the relief 501. This can prevent the input/output unit 102 from suffering the positional displacement relative to the main body 101. Moreover, the relief 501 also enables the positioning for overlapping the main body 101 and the input/output unit 102 with each other in the correct orientation.

While FIGS. 19A and 19B present the relief 501 being relatively large, it is configured to have dimensions to an extent to which sliding the input/output unit 102 to be detached from the main body 101 is not disturbed. Namely, the relief 501 is configured to have dimensions and shape in which sliding the input/output unit 102 relative to the main body 101 with force not less than predetermined force exerted on the relief 501 is not disturbed by the relief 501. Therefore, providing the relief 501 does not disturb the detachment of the input/output unit 102 from the main body 101, this enabling deterioration of usability to be prevented.

Moreover, the relief 501 is configured to have dimensions and shape in which the force below the predetermined force can be accepted by the relief 501 not to suffer the positional displacement. Hence, the positional displacement can be prevented from arising.

FIG. 19A exemplarily illustrates the main body 101 in which the relief 501 is provided to have the shape which rounds the outer circumferential portion of the display unit 111, whereas the shape of the relief 501 is not limited to such a shape. For example, the shape can be configured to round intermittently not continuously.

Moreover, it can be configured to perform the contact charging, including the terminal 112 and the terminal 122 as illustrated in FIG. 1 and the like, further including the relief 501.

### <Attachment on Rear Face>

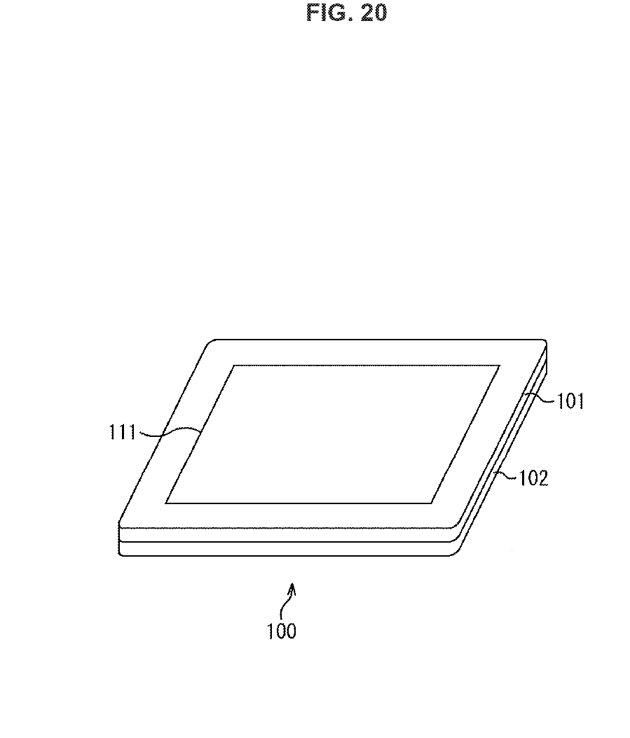

In the above-mentioned embodiments, the description is made for the input/output unit 102 attached to the display unit 111 side of the main body 101, whereas the input/output unit 102 can be attached to the rear face side of the main body 101. FIG. 20 is a diagram illustrating a configuration of appearance of the information processing apparatus 100 when the input/output unit 102 is attached to the rear face side of the main body 101.

The display unit 111 of the main body 101 is on the front face side for the user being able to see it visually. The input/output unit 102 is attached to the rear face side of the main body 101 (lower portion in the figure). The input/output unit 102 is attached to the main body 101 such that the face of the keyboard 121 of the input/output unit 102 faces the rear face of the main body 101.

As illustrated in FIG. 20, the input/output unit 102 is attached to the rear face side of the main body 101, and thereby, the information processing apparatus 100 can be used as a tablet-type personal computer. Moreover, since the input/output unit 102 is attached to the rear face side of the main body 101, when the user wants the keyboard 121, such request can be processed immediately.

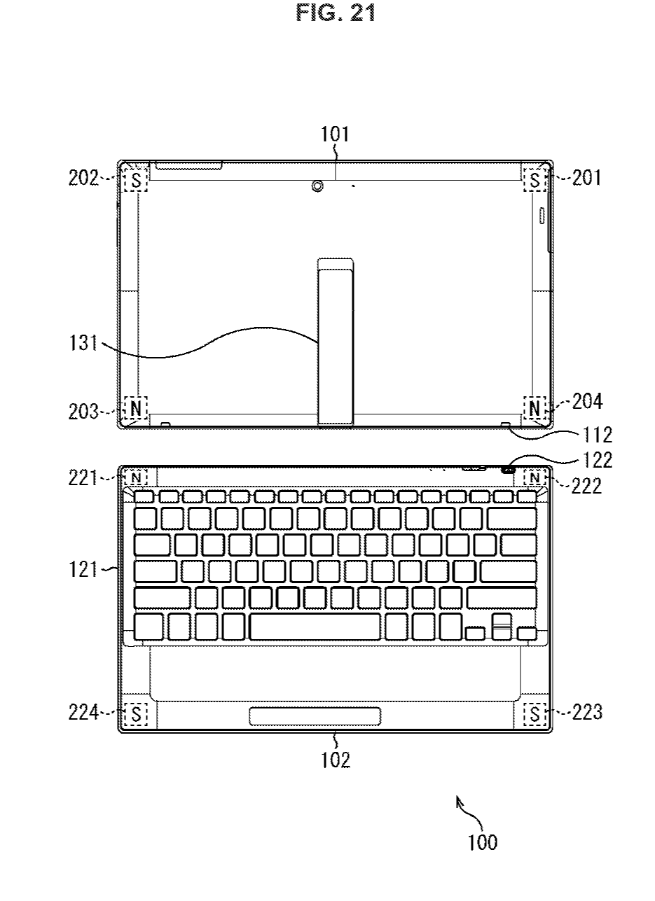

As above, when the input/output unit 102 can be attached to the rear face side of the main body 101 as well as on the front face thereof, the magnets are expected to be also provided on the rear face side of the main body 101. FIG. 21 exemplarily illustrates arrangements of the magnets. FIG. 21 exemplarily illustrates an arrangement of the magnets on the rear face side of the main body 101 and an arrangement of the magnets on the keyboard 121 (front face) side of the input/output unit 102.

The arrangement of the magnets on the front face side of the input/output unit 102 is same as the arrangement of the magnets on the front face side of the input/output unit 102 illustrated in FIG. 7. While the arrangement of the magnets on the front face of the main body 101 is not illustrated in FIG. 21, it is same as the arrangement of the magnets on the front face of the main body 101 illustrated in FIG. 7. Namely, the example illustrated herein is an example in which the magnets on the front face of the main body 101 illustrated in FIG. 7 are also used for the magnets on the rear face side. For example, the magnet 201 is used as the N-pole on the front face and used as the S-pole on the rear face side.

Referring to FIG. 21, on the rear face side of the main body 101, the magnet 202 which shows the S-pole is located in the top left thereof, the magnet 201 which shows the S-pole is located in the top right thereof, the magnet 204 which shows the N-pole is located in the bottom right and the magnet 203 which shows the N-pole is located in the bottom left. When the input/output unit 102 is attached to the rear face side of the main body 101, the magnet 201 which shows the S-pole on the main body 101 and the magnet 221 which shows the N-pole on the input/output unit 102 are overlapped with each other, and the magnet 202 which shows the S-pole on the main body 101 and the magnet 222 which shows the N-pole on the input/output unit 102 are overlapped with each other, this allowing the input/output unit 102 to be attached to the rear face side of the main body 101.

Similarly, when the input/output unit 102 is attached to the rear face side of the main body 101, the magnet 203 which shows the N-pole on the main body 101 and the magnet 223 which shows the S-pole on the input/output unit 102 are overlapped with each other, and the magnet 204 which shows the N-pole on the main body 101 and the magnet 224 which shows the N-pole on the input/output unit 102 are overlapped with each other, this allowing the input/output unit 102 to be attached to the rear face side of the main body 101.

As above, the magnets are arranged in the main body 101 and the input/output unit 102, this enabling the input/output unit 102 to be attached also to the rear face side of the main body 101. The main body 101, solely, can be used as a tablet-type personal computer, and this having the input/output unit 102 attached to the rear face side of the main body 101 can also be used as a tablet-type personal computer.

When the input/output unit 102 is configured to be able to be attached to the rear face side of the main body 101 and the input/output unit 102 includes the terminal 122 as above, a portion which contains the terminal 122 is provided on the rear face of the main body 101. Moreover, when the portion which contains the terminal 122 is provided on the rear face of the main body 101, the portion is configured similarly to the terminal 112. Thereby, the battery 183 of the input/output unit 102 can be configured to be charged still when the input/output unit 102 is attached to the rear face side of the main body 101.

When the information processing apparatus 100 is configured to perform the contactless charging, the power supplying unit 401 is also provided on the rear face side of the main body 101. Thereby, the battery 183 of the input/output unit 102 can be configured to be charged still when the input/output unit 102 is attached to the rear face side of the main body 101.

In the above-mentioned embodiments, it is described that the magnets of the main body 101 used when the input/output unit 102 is attached on the front face of the main body 101 are shared by way of example as the magnets of the main body 101 used when the input/output unit 102 is attached on the rear face of the main body 101, whereas a configuration with no such sharing is also possible. Namely, the magnets of the main body 101 used when the input/output unit 102 is attached on the front face of the main body 101 and the magnets of the main body 101 used when the input/output unit 102 is attached on the rear face of the main body 101 may be provided individually on the front face and on the rear face, respectively.

### <Overlapping for Information Processing Apparatus Using Electromagnets>

In the above-mentioned embodiments, the description is made for permanent magnets as the magnets, whereas electromagnets may be used as the magnets. For example, the magnets included in the main body 101 can be electromagnets and the magnets included in the input/output unit 102 can be the permanent magnets.

In the case of using the electromagnets, the strength of the magnetic force can be controlled according to the magnitude of current allowed to flow therethrough. Therefore, for example, the main body 101 and the input/output unit 102 can be configured, when they are overlapped with each other, to allow the current to flow through the electromagnets for maintaining that the main body 101 and the input/output unit 102 are overlapped with each other and, when the main body 101 and the input/output unit 102 are not overlapped with each other, to shut the current for reducing the power consumption.

Moreover, when the main body 101 and the input/output unit 102 are being overlapped with each other, relatively large current is allowed to flow through the electromagnets to enhance the magnetic force for introducing the input/output unit 102 to be overlapped with the main body 101 in the correct orientation. Then, after they are overlapped with each other, the current is decreased to maintain the overlapping.

A predetermined sensor may detect whether the input/output unit 102 is about to be attached to the main body 101. For example, a sensor for sensing magnetic force provided in the input/output unit 102 is used. Since the attachment under operation causes the input/output unit 102 to come close to the main body 101, the magnetic force from the magnets of the input/output unit 102 strengthens. The input/output unit 102 can be configured to sense such a change in magnetic force, and thus, to sense whether it is about to be attached to the main body 101.

Moreover, using a brightness sensor or the like, the input/output unit 102 can be configured to sense whether or not it is about to be attached to the main body 101 by sensing a change in illuminance due to the input/output unit 102 coming close thereto.

Moreover, in the case of using the electromagnets, changing the direction of the current flowing enables the poles of the magnets to be changed. For example, in the case that the input/output unit 102 is caused to be apart from the main body 101 when the main body 101 and the input/output unit 102 are overlapped, the direction of the flow of the current is reversed such that the magnets of the main body 101 and the input/output unit 102 repel each other. In this way, the user is easy to detach the input/output unit 102 from the main body 101, this assisting processing that the user wants to perform.

For example, a button may be provided for being operated when the input/output unit 102 is detached from the main body 101 to change the direction of the flow of the current upon operation of the button.

Moreover, when the button is operated, the supply of power to the electromagnets may be shut instead of changing the direction of the flow of the current. Shutting the supply of the power to the electromagnets negates the force between the main body 101 and the input/output unit 102 and the input/output unit 102 is easy to be detached from the main body 101. Therefore, still when the button is operated, shutting the supply of power to the electromagnets can also assist the user.

Moreover, the information processing apparatus 100 can be configured to include an accelerometer, GPS (Global Positioning System) or the like and to be able to detect as carried and moved or as placed on the desktop or the like. For example, when the accelerometer or the GPS detects that the information processing apparatus 100 is being moved, the current is allowed to flow through the electromagnets to maintain the main body 101 and the input/output unit 102 to be locked to each other.

On the other hand, when the accelerometer or the GPS detects that the information processing apparatus 100 is not being moved, the current allowed to flow through the electromagnets is reduced since the locking is hard to be released due to external force still in the case the main body 101 and the input/output unit 102 are locked to each other.

In the embodiments, using the electromagnets allows the configurations as above.

According to embodiments of the present technology, the main body 101 and the input/output unit 102, which are different devices, can be used apart from each other and can also be used to carry as a tablet with them overlapped with each other. For example, the display and the keyboard, which are different devices, can be used in association with each other when they are wanted to be used in association with each other or can be used as a tablet with the keyboard attached to the display when they are not used in association with each other.

Herein, the description is made that the main body 101 supplies power to charge the battery 183 of the input/output unit 102 when the input/output unit 102 is overlapped with the main body 101. Namely, the description is made that a device which performs the charging (supplies power) and a device which is charged (receives the power) are provided and that the charging is performed when the device which performs the charging and the device which is charged are overlapped with each other. An embodiment of the present technology can be applied also to a combination of the device which performs the charging and the device which is charged as above.

In the present specification, a system represents a whole apparatus constituted of a plurality of devices.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

a first device including a display unit;

a second device configured to perform at least one of input and output of information and to perform transfer of the information to/from the first device by communication; and

a wrong orientation detection part configured to detect whether or not the first device and the second device are overlapped with each other in a correct orientation,

wherein the first device includes a plurality of first magnets,

wherein the second device includes a plurality of second magnets,

wherein the first magnets and the second magnets are arranged at respective positions which overlap with each other when the first device and the second device are overlapped with each other, in the first device and the second device, respectively, and

wherein the first device and the second device are locked to each other by force with which the first magnets and the second magnets attract each other when the first device and the second device are overlapped with each other.

(2) The information processing apparatus according to (1),

wherein the wrong orientation detection part is configured such that at least one pole of the first magnet out of poles of the plurality of first magnets on a face side on which the display unit is included is a different pole from the others of the first magnets.

(3) The information processing apparatus according to (1),

wherein the first device further includes a power supplying terminal configured to supply power to the second device,

wherein the second device further includes a power receiving terminal configured to receive the power supplied from the first device,

wherein the power supplying terminal and the power receiving terminal are arranged at respective positions where the power supplying terminal and the power receiving terminal are set in a connection state when the first device and the second device are overlapped with each other, in the first device and the second device, respectively, and

wherein a battery of the second device is charged when the power supplying terminal and the power receiving terminal are connected to each other.

(4) The information processing apparatus according to (3),

wherein one of the power supplying terminal and the power receiving terminal has a convex shape with a curved surface on a part of the shape and the other has a concave shape with a curved surface on a part of the shape.

(5) The information processing apparatus according to (4),

wherein the wrong orientation detection part is constituted of the power supplying terminal and the power receiving terminal.

(6) The information processing apparatus according to (1),

wherein the first device further includes a power supplying unit configured to supply power to the second device,

wherein the second device further includes a power receiving unit configured to receive the power supplied from the first device,

wherein the power supplying unit and the power receiving unit are arranged at respective positions where the power supplying unit and the power receiving unit are overlapped with each other when the first device and the second device are overlapped with each other, in the first device and the second device, respectively, and

wherein a battery of the second device is charged when the power supplying unit and the power receiving unit are overlapped with each other.

(7) The information processing apparatus according to any one of (1) to (6),

wherein the second device is a device including at least any of a keyboard, a touch pad, a pen tablet and a loud speaker.

(8) The information processing apparatus according to any one of (1) to (7),

wherein the second device is configured to be overlapped on a face on which the display unit of the first device is provided or on a rear face of the first device and an overlapping state thus configured is maintained by the force with which the first magnets and the second magnets attract each other.

(9) The information processing apparatus according to any one of (1) to (8), configured to function as a tablet-type personal computer when the second device is overlapped on a rear face of the first device.

(10) The information processing apparatus according to any one of (1) to (9),

wherein a part in the second device corresponding to the display unit is configured to be depressed below an edge part of the second device such that the display unit of the first device does not come into contact with the second device when the first device and the second device are overlapped with each other.

(11) The information processing apparatus according to any one of (1) to (10),

wherein a supporting part configured to support the first device is provided on a rear face of the first device, and

wherein the supporting part is provided to be opened and closed freely with respect to the first device.

(12) The information processing apparatus according to any one of (1) to (11),

wherein a relief is provided in an outer circumferential part of the display unit of the first device.

(13) An information processing apparatus including:

a first device configured to supply power;

a second device configured to receive the power supplied from the first device; and

a wrong orientation detection part configured to detect whether or not the first device and the second device are overlapped with each other in a correct orientation,

wherein the first device includes a plurality of first magnets,

wherein the second device includes a plurality of second magnets,

wherein the first magnets and the second magnets are arranged at respective positions which overlap with each other when the first device and the second device are overlapped with each other, in the first device and the second device, respectively, and

wherein the first device and the second device are locked to each other by force with which the first magnets and the second magnets attract each other when the first device and the second device are overlapped with each other.

What is claimed is:

1. An information processing apparatus comprising:
a first device including a display unit;
a second device configured to perform at least one of input and output of information and to perform transfer of the information to/from the first device by communication; and
a wrong orientation detection part configured to detect whether or not the first device and the second device are overlapped with each other in a correct orientation,
wherein the first device includes a plurality of first magnets,
wherein the second device includes a plurality of second magnets,
wherein the first magnets and the second magnets are arranged at respective positions which overlap with each other when the first device and the second device are overlapped with each other, in the first device and the second device, respectively, and
wherein the first device and the second device are locked to each other by force with which the first magnets and the second magnets attract each other when the first device and the second device are overlapped with each other.

2. The information processing apparatus according to claim 1,
wherein the wrong orientation detection part is configured such that at least one pole of the first magnet out of poles of the plurality of first magnets on a face side on which the display unit is included is a different pole from the others of the first magnets.

3. The information processing apparatus according to claim 1,
wherein the first device further includes a power supplying terminal configured to supply power to the second device,
wherein the second device further includes a power receiving terminal configured to receive the power supplied from the first device,
wherein the power supplying terminal and the power receiving terminal are arranged at respective positions where the power supplying terminal and the power receiving terminal are set in a connection state when the first device and the second device are overlapped with each other, in the first device and the second device, respectively, and
wherein a battery of the second device is charged when the power supplying terminal and the power receiving terminal are connected to each other.

4. The information processing apparatus according to claim 3,
wherein one of the power supplying terminal and the power receiving terminal has a convex shape with a curved surface on a part of the shape and the other has a concave shape with a curved surface on a part of the shape.

5. The information processing apparatus according to claim 4,
wherein the wrong orientation detection part is constituted of the power supplying terminal and the power receiving terminal.

6. The information processing apparatus according to claim 1,
wherein the first device further includes a power supplying unit configured to supply power to the second device,
wherein the second device further includes a power receiving unit configured to receive the power supplied from the first device,
wherein the power supplying unit and the power receiving unit are arranged at respective positions where the power supplying unit and the power receiving unit are overlapped with each other when the first device and the second device are overlapped with each other, in the first device and the second device, respectively, and
wherein a battery of the second device is charged when the power supplying unit and the power receiving unit are overlapped with each other.

7. The information processing apparatus according to claim 1,
wherein the second device is a device including at least any of a keyboard, a touch pad, a pen tablet and a loud speaker.

8. The information processing apparatus according to claim 1,
wherein the second device is configured to be overlapped on a face on which the display unit of the first device is provided or on a rear face of the first device and an overlapping state thus configured is maintained by the force with which the first magnets and the second magnets attract each other.

9. The information processing apparatus according to claim 1, configured to function as a tablet-type personal computer when the second device is overlapped on a rear face of the first device.

10. The information processing apparatus according to claim 1,
wherein a part in the second device corresponding to the display unit is configured to be depressed below an edge part of the second device such that the display unit of the first device does not come into contact with the second device when the first device and the second device are overlapped with each other.

11. The information processing apparatus according to claim 1,
wherein a supporting part configured to support the first device is provided on a rear face of the first device, and
wherein the supporting part is provided to be opened and closed freely with respect to the first device.

12. The information processing apparatus according to claim 1,
wherein a relief is provided in an outer circumferential part of the display unit of the first device.

13. An information processing apparatus comprising:
a first device configured to supply power;
a second device configured to receive the power supplied from the first device; and
a wrong orientation detection part configured to detect whether or not the first device and the second device are overlapped with each other in a correct orientation,
wherein the first device includes a plurality of first magnets,
wherein the second device includes a plurality of second magnets,
wherein the first magnets and the second magnets are arranged at respective positions which overlap with each other when the first device and the second device are overlapped with each other, in the first device and the second device, respectively, and
wherein the first device and the second device are locked to each other by force with which the first magnets and the second magnets attract each other when the first device and the second device are overlapped with each other.
